(19) United States
(12) Patent Application Publication
(10) Pub. No.: US 2012/0093502 A1
(43) Pub. Date: Apr. 19, 2012

(54) MODE-HOP PREVENTION IN A TUNABLE LASER OF AN OPTICAL NETWORK ELEMENT

(75) Inventors: Erich Gottwald, Holzkirchen (DE); Harald Rohde, Munchen (DE); Thomas Treyer, Munchen (DE)

(73) Assignee: Nokia Siemens Networks Oy, Espoo (FI)

(21) Appl. No.: 13/380,132

(22) PCT Filed: Jun. 22, 2009
(86) PCT No.: PCT/EP2009/057732

§ 371 Date: Jan. 10, 2012

(51) Int. Cl. H04B 10/08; H04J 14/04

(52) U.S. Cl. 398/27; 398/44; 398/25

(57) ABSTRACT

A method for data processing in an optical network element is provided. An event of a forthcoming mode-hop of a tunable laser is detected. Furthermore, a corresponding optical network element and an optical communication system with at least one such optical network element are described.

The invention relates to a method for data processing in an optical network element and to such an optical network element. Furthermore, an optical communication system comprising at least one such optical network element is suggested.

A passive optical network (PON) is a promising approach regarding fiber-to-the-home (FTTH), fiber-to-the-business (FTTB) and fiber-to-the-curb (FTTC) scenarios, in particular as it overcomes the economic limitations of traditional point-to-point solutions.

Several PON types have been standardized and are currently being deployed by network service providers worldwide. Conventional PONs distribute downstream traffic from the optical line terminal (OLT) to optical network units (ONUs) in a broadcast manner while the ONUs send upstream data packets multiplexed in time to the OLT. Hence, communication among the ONUs needs to be conveyed through the OLT involving electronic processing such as buffering and/or scheduling, which results in latency and degrades the throughput of the network.

In fiber-optic communications, wavelength-division multiplexing (WDM) is a technology which multiplexes multiple optical carrier signals on a single optical fiber by using different wavelengths (colors) of laser light to carry different signals. This allows for a multiplication in capacity, in addition to enabling bidirectional communications over one strand of fiber.

WDM systems are divided into different wavelength patterns, conventional or coarse and dense WDM. WDM systems provide, e.g., up to 16 channels in the 3rd transmission window (C-band) of silica fibers of around 1550 nm. Dense WDM uses the same transmission window but with denser channel spacing. Channel plans vary, but a typical system may use 40 channels at 100 GHz spacing or 80 channels with 50 GHz spacing. Some technologies are capable of 25 GHz spacing. Amplification options enable the extension of the usable wavelengths to the L-band, more or less doubling these numbers.

Optical access networks, e.g., a coherent Ultra-Dense Wavelength Division Multiplex (UDWDM) network, are deemed to be the future data access technology.

Upstream signals may be combined by using a multiple access protocol, e.g., invariable time division multiple access (TDMA). The OLTs “range” the ONUs in order to provide time slot assignments for upstream communication. Hence, an available data rate is distributed among many subscribers. Therefore, each ONU needs to be capable of processing much higher than average data rates. Such an implementation of an ONU is complex and costly.

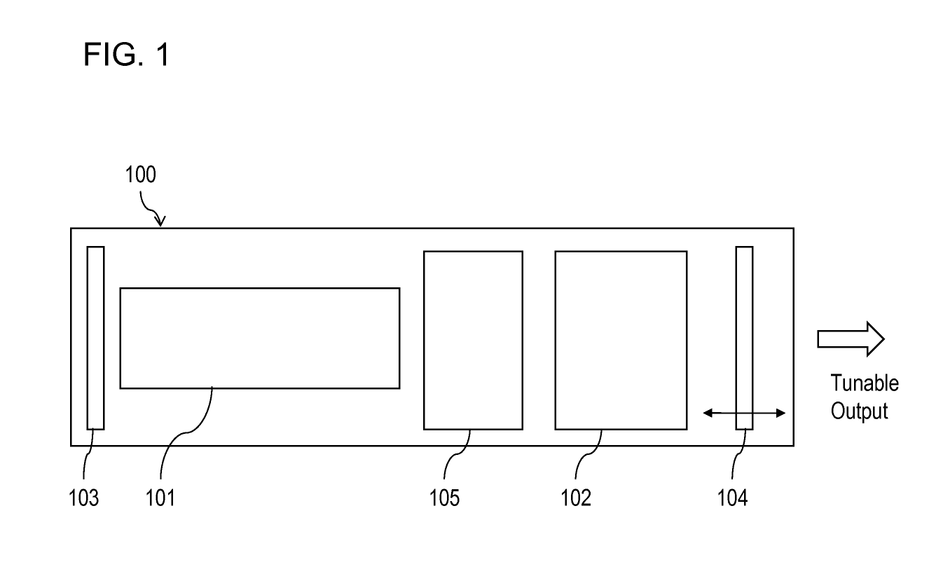

In order to provide a more cost efficient approach, for the purpose of coherent detection, the ONU may be equipped with a less complex and inexpensive local oscillator laser that is tunable over a wide wavelength range, e.g., the C-band (>4 THz scanning range). However, such less complex tunable lasers with external tunable feedback bear the disadvantage of mode-hops when being tuned. FIG. 1 shows a schematic of a generic tunable single-frequency laser 100 comprising a gain 101, a mode-selection filter 102, a phase shifter 105 and two mirrors 103, 104. The mode-selection filter 102 allows frequency tuning of the laser.

Because of the dense channel spacing in UDWDM systems amounting to the order of a few GHz, the probability of mode-hops while locking to a channel or tracking a channel is considerably high. Operating the laser at a frequency range close to such mode-hop avoids a stable long term operation and may further result in a phase noise degrading bit error rate.

Tuning such laser by merely using the mode-selection filter 102 results in mode-hops and therefore hops in frequency. This may lead to an interruption of the data stream, which is perceivable to a user.

On the other hand, synchronizing the phase shifter 105 of the single-frequency laser while tuning the mode selection filter 102 would require an exact knowledge of characteristics of the laser regarding a huge set of parameters like, e.g., temperature, spectral position of the filter, laser current, etc. In case one of such parameters is not monitored and/or not controlled accordingly, any synchronized tuning avoiding said mode-hops is not possible.

The problem to be solved is to overcome the disadvantages stated above and in particular to provide a cost-efficient ONU implementation utilizing an inexpensive local oscillator laser and avoiding or reducing re-synchronization due to mode-hops.

This problem is solved according to the features of the independent claims. Further embodiments result from the depending claims.

In order to overcome this problem, a method for data processing in an optical network element is provided
wherein an event of a forthcoming mode-hop of a tunable laser is detected.

According to an embodiment, a frequency of the tunable laser is adjusted based on the forthcoming mode-hop detected.

Hence, based on such event of the forthcoming mode-hop detected, the frequency of the tunable laser can be adjusted in time prior to the actual mode-hop. This advantageously avoids any outage that would deteriorate a user's experience. Hence, advantageously, less complex tunable lasers can be utilized, which allows for a cost-efficient implementation of the optical network element.

In an embodiment, said forthcoming mode-hop of the tunable laser is detected by monitoring a phase noise and/or amplitude noise of the tunable laser.

In another embodiment, said forthcoming mode-hop of the tunable laser is detected by monitoring a bit-error rate.

In a further embodiment, said forthcoming mode-hop of the tunable laser is detected by monitoring a control signal of a Costas loop and/or any carrier tracking loop.

In a next embodiment, said forthcoming mode-hop of the tunable laser is detected by monitoring an amplitude noise via a photodiode.

It is also an embodiment that said forthcoming mode-hop of the tunable laser is detected by monitoring a signal reflected and mixed with light from the local oscillator in the electrical domain, in particular in an electrical frequency domain.

Pursuant to another embodiment, said forthcoming mode-hop of the tunable laser is detected by monitoring an electrical power at a bandwidth range that does not overlap with the signal.

According to an embodiment, the OLT is informed about the forthcoming mode-hop after the event has been detected.

Such information can be signaled towards the OLT from an ONU. Hence, the centralized OLT can advantageously conduct steps to be required for efficiently adjusting parameters at the ONU. In particular, a smooth adjustment prior to reaching an actual mode-hop can be provided.

According to another embodiment, the OLT buffers data (at least) until the frequency of the tunable laser is adjusted.

When establishing signaling between ONU and OLT (with or without acknowledgement), the OLT is aware of the adjustment(s) to be conducted at the ONU and may thus buffer data accordingly. After such adjustment, the ONU may indicate to the OLT to convey the data buffered. As an alternative, the OLT may automatically convey such data after a predetermined period of time (which may be indicated by a lapsing timer at the OLT). In this case, the ONU does not have to provide any further signaling to the OLT to indicate that the adjustment has been concluded.

In yet another embodiment, the frequency of the tunable laser is adjusted via a coarse adjustment and a subsequent fine tuning of said frequency.

In particular, such two-stage processing is of advantage as it allows for a fast and efficient adjustment of the tunable laser's frequency. The adjustment may in particular result in a target frequency which is within a safe zone afar from a mode-hop boundaries.

According to a next embodiment, the frequency of the tunable laser is adjusted by utilizing at least one of the following steps:
adjusting a mode of a filter of the tunable laser;
adjusting a current of the tunable laser;
adjusting a temperature of the tunable laser.

Hence, the coarse adjustment may comprise said adjusting of the tunable laser's filter and the fine tuning may comprise said adjusting of the current of the tunable laser.

Pursuant to yet an embodiment, the optical network element is an ONU or an OLT.

The problem stated above is also solved by a device comprising and/or being associated with a processor unit and/or a hard-wired circuit and/or a logic device that is arranged such that the method as described herein is executable thereon.

Also, the problem stated supra can be solved by an optical network element comprising
a tunable laser,
a mode-hop detector that is arranged to detect an event of a forthcoming mode-hop of the tunable laser.

According to an embodiment, the optical network element comprises a tuning control unit that is used for adjusting at least one parameter of the tunable laser.

Such tunable control unit may be connected to the mode-hop detector to adjust the at least one parameter of the tunable laser based on an forthcoming mode-hop detected by said mode-hop detector.

The mode-hop detector may indicate the event of a forthcoming mode-hop to the tuning control unit.

It is noted that the tuning control unit and/or the mode-hop detector may be deployed with the tunable laser. They may or may not be implemented as separate entities, they may be functionally associated with either one or any other component of the optical network element.

According to an embodiment, the mode-hop detector and/or the tuning control unit are arranged such that the method as described herein can be executed.

The problem stated supra is further solved by an optical communication system comprising the one optical network element as described herein.

Embodiments of the invention are shown and illustrated in the following figure:

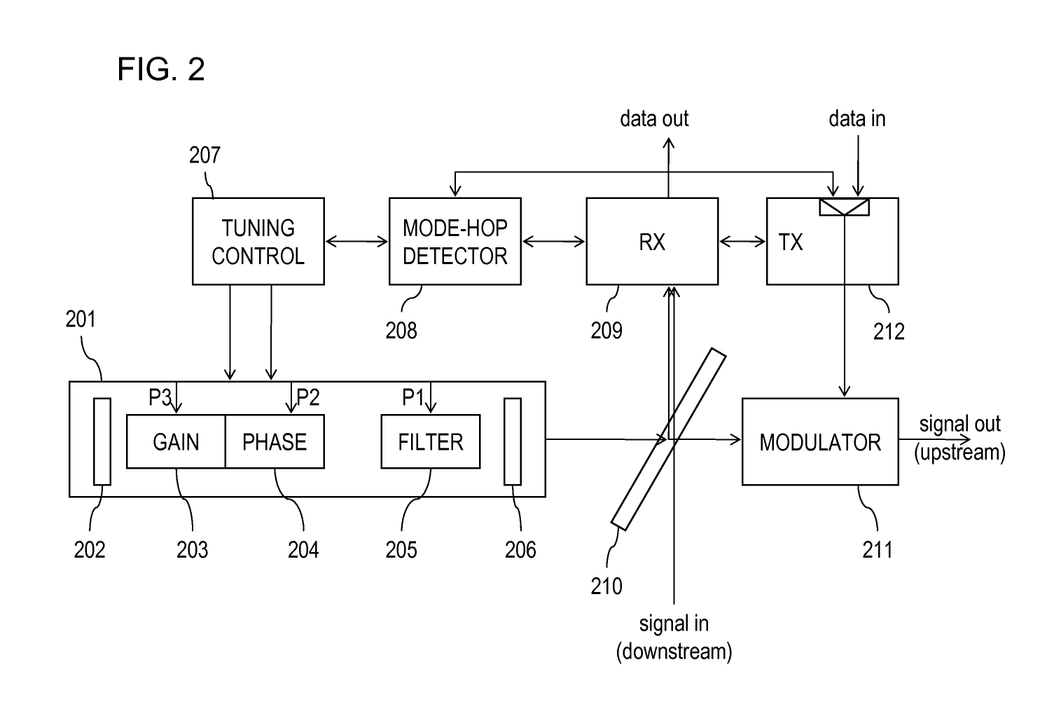

FIG. 2 shows a block diagram of a schematic realization of a ONU utilizing a local oscillator laser.

The approach presented herein allows for “synchronized” mode-hops and sets tuning parameters of a laser such that in an frequency range with sufficient width around a data channel no mode-hops will occur.

FIG. 2 shows a block diagram of a schematic realization of a ONU utilizing a local oscillator laser 201.

The local oscillator laser 201 comprises a mirror 202, a gain 203, a phase shifter 204, a filter 205 (e.g., a mode-selection filter) and a mirror 206 that allows partial transmission of an optical signal towards another partially transmitting mirror 210. The signal from the local oscillator laser 201 is fed to a receiver 209 and to a modulator 211.

A downstream incoming signal is directed via said mirror 210 to the receiver 209 and further (after being processed by said receiver 209) an output data signal “data out” is provided by said ONU.

Incoming data “data in” is processed at a transmitter 212 and fed to a modulator 211, where it is modulated together with the signal from the local oscillator laser 201 and conveyed via an upstream outgoing signal towards the OLT (not shown in FIG. 2).

In addition, a mode-hop detector 208 is provided that is connected to the receiver 209, to a tuning control 207 as well as to the transmitter 212.

The tuning control 207 may adjust at least two parameters of the local oscillator laser 201 (indicated by two arrows pointing towards the local oscillator laser 201). The local oscillator laser comprises three exemplary parameter P1, P2 and P3, wherein said parameter P3 is used for adjusting the gain 203, the parameter P2 is used for adjusting the phase shifter 204 and the parameter P1 is used for adjusting the filter 205.

A wavelength (frequency) of a wide range tunable laser depends on at least two parameters. For example, a parameter P1 adjusts settings of an external cavity filter and a parameter P2 adjusts tuning ranges within one mode. The tuning ranges of parameters P1 and P2 may overlap.

Under long-term conditions pursuant to temperature drifts or based on tracking drifts of the channel wavelength, the laser 201 reaches a boundary of a “safe” tuning range. Hence, at such boundary of a tuning range, the risk of losing synchronization and thus the risk of an interruption of data processing significantly increases. Such boundary can be determined in advance and/or it can be dynamically set based on past re-synchronization events.

Reaching the boundary of such safe tuning range, the ONU may indicate (e.g., by in-band signaling) to the OLT that the laser parameters need to be adjusted and a new locking is required. This may cause a short outage in data transmission, which may advantageously be buffered at the OLT. Due to the shortness of the outage, the data may be buffered without having to provide for significant memory space at the OLT. Also, the shortness of the outage may be beyond user's perception, i.e. the service provided to the user is rather continuous, the (short) outage can be well compensated by said means of buffering. In other words, the anticipation of a forthcoming mode-hop avoids rather tedious re-synchronization combined with an outage that would deteriorate the user's experience.

Based on such indication by the ONU, the OLT may perform necessary steps to support such a re-synchronization.

Hence, the approach provided herein in particular supports a detection of a forthcoming mode-hop, signaling such event to the OLT and readjusting the ONU in a controlled manner without any loss of synchronization and connection. Preferably, no outage perceivable to the user will occur and the user experience may not suffer due to such adjustment of parameters.

It is a significant advantage that this approach allows utilization of less complex and inexpensive lasers at the ONU, which leads to a significant cost saving regarding the implementation of the ONU.

Advantageously, any forthcoming mode-hop is to be detected in time. A mode-hop may be detected based on increasing phase noise and/or based on amplitude noise of the tunable laser. Hence, a bit-error rate or a control signal of a Costas loop (e.g., in case of heterodyne detection of DQPSK) or any other carrier tracking loop at the receiver site can be utilized for detecting such forthcoming mode-hop. Such scenarios may be applicable in case the laser is locked to the signal while tracking is conducted.

In case of scanning of the local oscillator (i.e., in case the laser is not locked to a received signal) other measures may be utilized, e.g., detecting an amplitude noise via a photodiode or analyzing the signal caused by back reflected light mixed with light from the local oscillator in the electrical frequency range close to zero, e.g., by monitoring the electrical power within a bandwidth interval not overlapping with that occupied by the signal.

### LIST OF ABBREVIATIONS

CWDM Coarse WDM
LO (optical) Local Oscillator
OLT Optical Line Terminal
ONT Optical Network Termination
ONU Optical Network Unit
PD Photo Diode
PM Phase Modulation unit
PON Passive Optical Network
UDWDM Ultra Dense WDM
WDM Wavelength Division Multiplex

1-14. (canceled)

15. A method for data processing in an optical network element, the method which comprises:
detecting an event of a forthcoming mode-hop of a tunable laser.

16. The method according to claim 15, which comprises adjusting a frequency of the tunable laser based on the forthcoming mode-hop detected in the detecting step.

17. The method according to claim 15, which comprises detecting the forthcoming mode-hop of the tunable laser by monitoring one or both of a phase noise or amplitude noise of the tunable laser.

18. The method according to claim 15, which comprises detecting the forthcoming mode-hop of the tunable laser by monitoring a bit-error rate.

19. The method according to claim 15, which comprises detecting the forthcoming mode-hop of the tunable laser by at least one process step selected from the group consisting of:
monitoring a control signal of a Costas loop and/or any carrier tracking loop;
monitoring an amplitude noise via a photodiode;
monitoring a signal reflected and mixed with light from a local oscillator in the electrical domain; and
monitoring an electrical power at a bandwidth range that does not overlap with the signal.

20. The method according to claim 19, wherein the electrical domain is an electrical frequency domain.

21. The method according to claim 15, which comprises informing an optical line terminal (OLT) about the forthcoming mode-hop after the event has been detected.

22. The method according to claim 21, which comprises buffering data by the OLT until the frequency of the tunable laser has been adjusted.

23. The method according to claim 15, which comprises adjusting a frequency of the tunable laser via a coarse adjustment and a subsequent fine tuning of the frequency.

24. The method according to claim 15, which comprises adjusting a frequency of the tunable laser by utilizing at least one process step selected from the group consisting of:
adjusting a mode of a filter of the tunable laser;
adjusting a current of the tunable laser; and
adjusting a temperature of the tunable laser.

25. The method according to claim 15, wherein the optical network element is an optical network unit (ONU) or an optical line terminal (OLT).

26. An optical network element, comprising:
a tunable laser; and
a mode-hop detector disposed and configured to detect an event of a forthcoming mode-hop of said tunable laser.

27. The optical network element according to claim 26, further comprising a tuning control unit connected to and configured for adjusting at least one parameter of said tunable laser.

28. The optical network element according to claim 27, wherein said mode-hop detector and said tuning control unit are configured for execution of the method according to claim 15.

29. The optical network element according to claim 26, wherein said mode-hop detector is configured for execution of the method according to claim 15.

30. An optical communication system, comprising at least one optical network element according to claim 26.
